(19) United States
(12) Patent Application Publication
(10) Pub. No.: US 2006/0112080 A1
(43) Pub. Date: May 25, 2006

(54) Converting digital video into a printed format

(75) Inventors: Bernard H. Chen, Venice, CA (US); Catherine E. Helmuth, Los Angeles, CA (US); Sairam B. Suresh, Cerritos, CA (US)

Correspondence Address: PATENT LAW GROUP LLP, 2635 NORTH FIRST STREET, SUITE 223, SAN JOSE, CA, 95134, US

(73) Assignee: FlipClips, Inc.

(21) Appl. No.: 10/996,003

(22) Filed: Nov. 23, 2004

(51) Int. Cl. G06F 17/30

(52) U.S. Cl. 707/3

(57) ABSTRACT

A method for producing flipbooks over a network includes receiving a video over the network from a client device, converting the video to a standard video format, adjusting a frame rate of the video to a standard frame rate, adjusting a frame size of the video to a standard frame size, generating a printable document from a group of videos including the video, wherein each page of the printable document includes one frame from each video in the group of videos, and printing the printable document to create a printed document. The method may further include cutting the printed document to form individual stacks of printed frames and binding the stacks to produce the individual flipbooks.

### FIELD OF INVENTION

This invention relates to digital video, and more specifically to a method for creating a flipbook from a digital video.

### BACKGROUND OF THE INVENTION

Unlike digital photography, digital video does not currently have a mainstream, commercial, analog medium to which it can be printed for the purposes of sharing and preservation. Digital video is instead typically shared via conventional digital venues such as computer screens and disks.

A flipbook is a small book consisting of a series of images that give the illusion of continuous movement when the edges of the pages are flipped quickly. Commercially produced flipbooks have been created and sold as a novelty since 1868 using drawings and photographs. These flipbooks are typically created using mass-production printing methods in large quantities.

More recently, software has been developed that allows the user to format and to print flipbooks using the user's own QuickTime-formatted video.

### BRIEF DESCRIPTION OF THE DRAWINGS

FIG. 1 is a flowchart of a method to create flipbooks in one embodiment of the invention.

FIG. 2 illustrates a system for creating flipbooks in one embodiment of the invention.

FIGS. 3 and 4 illustrate the collating of multiple flipbook orders into a single print job for creating multiple flipbooks in one embodiment of the invention.

Use of the same reference numbers in different figures indicates similar or identical elements.

### SUMMARY OF THE INVENTION

One object of this invention is to provide a method for producing flipbooks over a network. The method in one embodiment includes receiving a video over the network from a client device, converting the video to a standard video format, adjusting a frame rate of the video to a standard frame rate, adjusting a frame size of the video to a standard frame size, generating a printable document from a group of videos including the video, wherein each page of the printable document includes one frame from each video in the group of videos, and printing the printable document to create a printed document. The method may further include cutting the printed document to form individual stacks of printed frames and binding the stacks to produce the individual flipbooks.

### DETAILED DESCRIPTION

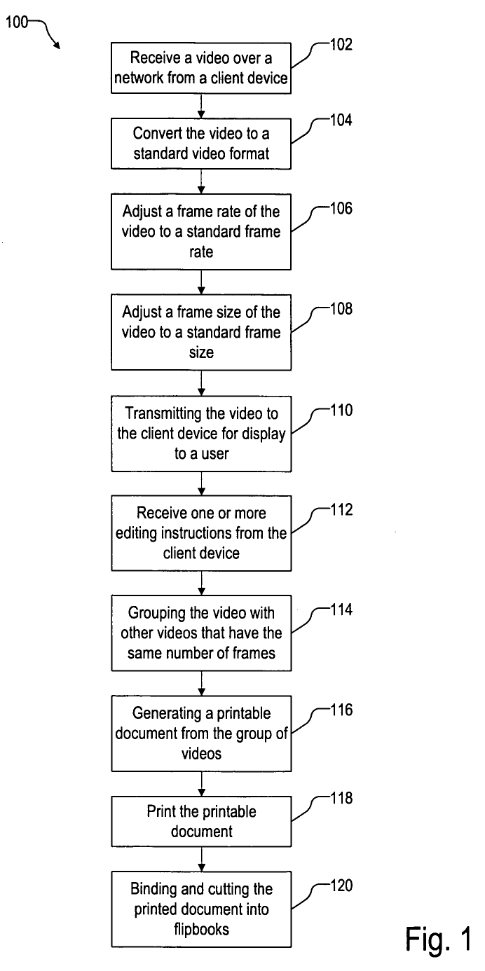

This (FIG. 1) is a flowchart of a method 100 for an online flipbook service that efficiently makes personalized flipbooks in one embodiment of the invention. Method 100 is able to produce small quantities (e.g., one or more) of personalized flipbooks of a customer's own content with the professional quality and consistency of a mass-produced flipbook.

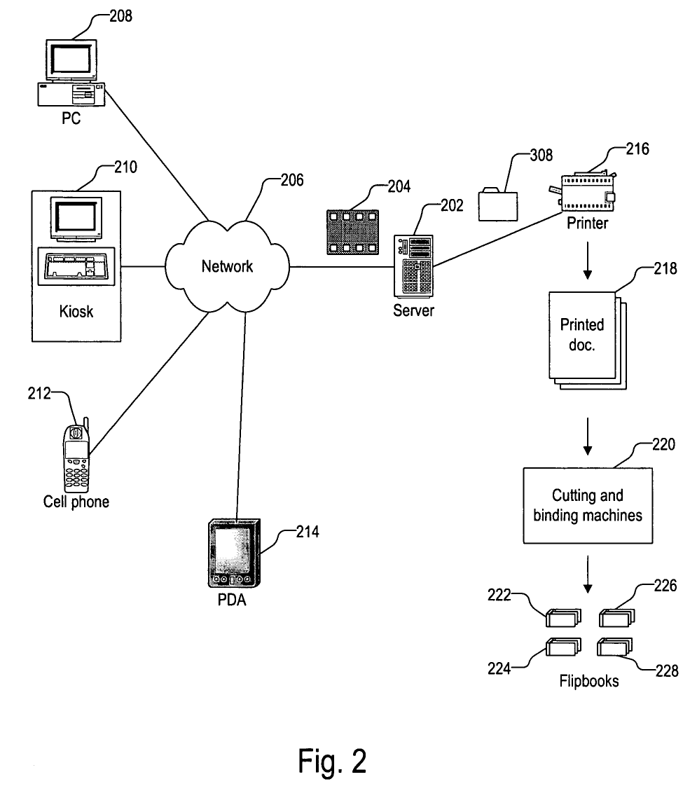

In step 102, a server 202 (FIG. 2) receives a sequence of images 204 (FIG. 2) from a client device over a network 206 (FIG. 2). Server 202 is typically a computer capable of storing a plurality of sequences of images transmitted by one or more users. In a preferred embodiment, the server has, in addition to storage capability, the ability to interact with one or more client devices, which may be used to provide instructions to the server. In another embodiment, server 202 may detect the presence of a client device and subsequently retrieve the images from the client device. Server 202 also may possess the ability to modify the sequence of images as well as the images themselves, as described herein. The network 206 which connects the server to the client device may be a wireless network, a wire- or land-line based network, or some combination thereof. Network 206 can be a public network (e.g., the Internet) or a private network (e.g. a cellular network) that has access to server 202.

The sequences of images contemplated by this invention generally may be any collection of images. However, in preferred embodiments, the images in the collection of images are arranged such that each image is slightly different from the previous image. Non-limiting examples of sequences of images contemplated by this invention include digital video, computer animation, a series of photographs, and a series of computer-generated or hand drawings.

The client device is not particularly limited and can be any device which is capable of storing images and connecting to a network so that the images may be transmitted. Non-limiting examples of client devices include a personal computer 208 (FIG. 2), a kiosk 210 (FIG. 2), a camera phone 212 (FIG. 2), a digital video recorder, a digital camera, a personal digital assistant 214 (FIG. 2), an MP3 device, other computer-peripheral device having the ability to connect to a network. In some embodiments, the user interacts with the client device in real-time to send instructions when transmitting the sequence of images. For example, a customer of the flipbook service may use conventional software (e.g., a conventional web browser) on a computer to upload video 204 to server 202 and to provide instructions to server 202. In another embodiment, the customer may transmit video 204 that is captured with a camera phone 212. The customer may further interact with server 202 by using the web browsing feature on camera phone 212. In other embodiments, the client device provides, in addition to the sequence of images, a set of predetermined instructions for editing the video

In step 104, server 202 converts the sequence of images into a format that is suitable for creating flipbooks in method 100. For example, when the sequence of images is in the form of a digital video 204, the server 202 may convert the digital video from any video format including avi, mov, and or mpg into a common format to be worked on by the server.

In step 106, server 202 adjusts the frame rate of video 204 to one of several predetermined frame rates used to create flipbooks in method 100. The frame rates of server 202 are arbitrary and may be specified by the user or the server. The frame rate depends on the size of the flipbook the customer wishes to order. The server may reduce or increase the total number of frames in video 204. In certain preferred embodiments, the number of frames is less than 300, and more preferably between 150 to 200 frames. However, this invention also contemplates situations where the total number of frames created by server 202 is greater than 300, such as, for example, when a customer desires a thick flipbook.

In step 108, server 202 adjusts the frame size of video 204. The frame size is adjusted in order to set the size of the image appearing on each page of the flip book. In principle, any frame size may be used, but in preferred embodiments, a standard frame sizes is adopted to create flipbooks in method 100. For example, server 202 operating on a digital video may adjust the frame size of video 204 to 1¼ by 3½ inches. The resulting frame size depends on the size of the flipbook the customer wishes to order.

In step 110, server 202 transmits a preview of the personalized flipbook to the client device for the customer. For example, the preview may be presented as a flash animation, whereby the sequence of images is shown in rapid succession to the customer. The preview may also allow the customer to review each image in the sequence of images one-by-one.

In step 112, server 202 receives one or more editing instructions from the customer using the client device or a predetermined set of instructions on the client device itself. For example, when the sequence of images is digital video, a customer on the client device may wish to change the length of the video, perform color corrections, add visual effects, split the video into multiple videos, merge multiple videos into one video, and further adjust the frame rate of the video. In response to the editing instructions, server 202 conventionally modifies video 204. Steps 110 and 112 may be repeated until the customer is satisfied with the result.

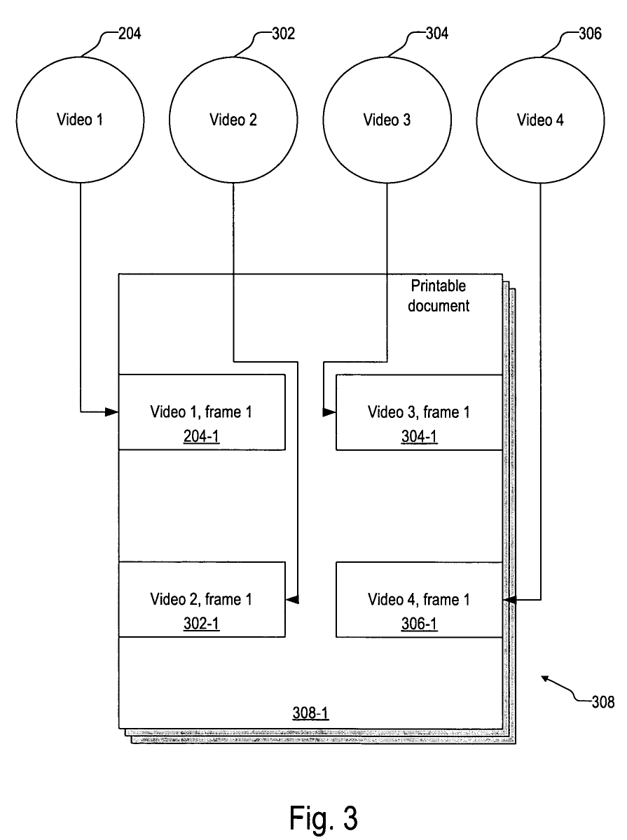

In step 114, server 202 groups video 204 with other videos 302, 304, and 306 (FIG. 3) that have the same number of frames. Videos 302, 304, and 306 have been submitted by other customers for the flipbook service. For cost saving purposes, server 202 will queue these videos until there is a sufficient number of them to generate a single print job as described below. Of course, fewer videos may be grouped for a single print job at the sacrifice of cost.

In step 116, server 202 generates a printable document 308 (FIGS. 2 and 3) from a group of videos having the same number of frames. Specifically, server 202 places one frame from each video onto each page of printable document 308. The number of frames that can be placed on each page of printable document 308 depends on the frame size and the page size of printable document 308. For example, a first page 308-1 (FIG. 3) of printable document 308 includes a first frame 204-1 from video 204, a first frame 302-1 (FIG. 3) from video 302, a first frame 304-1 (FIG. 3) from video 304, and a first frame 306-1 (FIG. 3) from video 306.

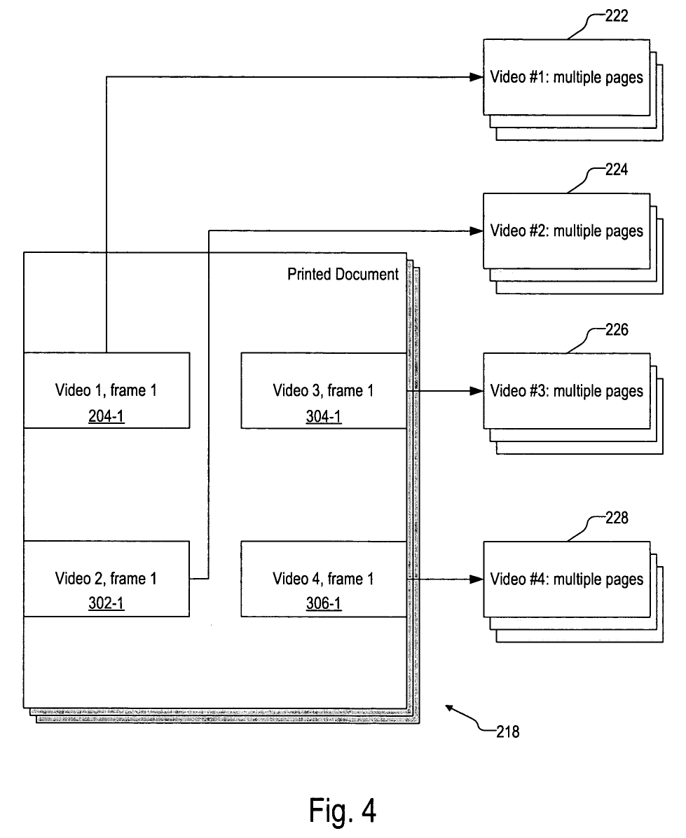

In step 118, server 202 sends printable document 308 to a digital printer 216 to generate a printed document 218 (FIGS. 2 and 4).

In step 120, printed document 218 is bound and cut (or vice versa) by professional equipment 220 (FIG. 2) to form flipbooks 222, 224, 226, and 228 (FIGS. 2 and 4). In one embodiment, the pages of printed document 218 are bound and then separated with 3 sided cuts to form individual stacks of frames from each video. Cutting and binding are performed with professional equipment 220 to create a look and feel not available to customers at home. Flipbooks 222 to 228 are then delivered to the respective customers.

As described above, an easy-to-use online method has been provided for non-technical users to be able to upload their personal digital videos for the purpose of creating their own custom flipbooks. By collating multiple flipbook orders into a single print job, the method efficiently produces small quantities of personalized flipbooks for the customers. Furthermore, whereas other flipbook providers use traditional presses that require calibrations, the present method uses digital printers that requires little configuration for each print job.

Various other adaptations and combinations of features of the embodiments disclosed are within the scope of the invention. For example, although flipbooks are specifically mentioned, method 100 may be used to create a book of personalized stickers that consist of the frames of the video, a notepad with a flipbook feature located on the pages of the notepad, and frames used to make a zoetrope. Numerous embodiments are encompassed by the following claims.

What is claimed is:

1. A method for producing flipbooks over a network, said method comprising:
receiving a sequence of images over the network from a client device;
converting the sequence of images to a standard video format;
adjusting a frame rate of the sequence of images to a standard frame rate;
adjusting the frame size of the sequence of images to a standard frame size;
generating a printable document from one or more sequences of images; and
printing the printable document to create a printed document.

2. The method of claim 1, wherein the sequence of images is a digital video.

3. The method of claim 1 wherein the sequence of images is a video, the method further comprising, prior to said generating a printable document:
grouping the video with other videos to form the group of videos because the other videos have a same number of frames as the video.

4. The method of claim 1, further comprising, after said printing the printable document:
cutting the printed document to form individual stacks of printed frames; and
binding the individual stacks to form the flipbooks.

5. The method of claim 1, wherein the client device is selected from the group consisting of a camera phone, a kiosk, a personal computer, and a personal digital assistant.

6. The method of claim 1 wherein the sequence of images is a video, the method further comprising:
receiving an editing instruction for the video from the client device;
editing the video in response to the editing instruction; and
transmitting the video after said editing to the client device for display to a customer.

7. The method of claim 5, wherein said editing the video is selected from the group consisting of editing a length of the video, correcting colors of the video, enhancing the video with a visual effect, splitting the video, merging the video with another video, and further adjusting the frame rate of the video.

8. The method of claim 1, wherein said printing the printable document comprises printing with a digital printer.

9. A method for producing flipbooks over a network, comprising:
receiving a video over the network from a client device;
adjusting a frame rate of the video to a standard frame rate;
adjusting a frame size of the video to a standard frame size;
converting the video to a standard video format;
grouping the video with other videos to form a group of videos having a same number of frames as the video;
generating a printable document from the group of videos, wherein each page of the printable document includes one frame from each video in the group of videos;
printing the printable document with a digital printer to create a printed document;
cutting the printed document to form individual stacks of printed frames; and
binding the individual stacks to form the flipbooks.

10. A plurality of pages, each page comprising a plurality of frames, each frame originating from a different video and form part of a different flipbook.
